(19) United States
(12) Patent Application Publication
(10) Pub. No.: US 2007/0101180 A1
(43) Pub. Date: May 3, 2007

(54) Method and a system or handling a change in status for a resource managed by a utility data center

(76) Inventors: John J. Mendonca, Cupertino, CA (US); Sudaresan Ramamoorthy, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,379

(22) Filed: Oct. 28, 2005

(51) Int. Cl. G06F 11/00

(52) U.S. Cl. 714/4

(57) ABSTRACT

Embodiments of the present invention pertain to methods and systems for handling a change in status for a resource managed by a utility data center. In one embodiment, an event that describes the change of status for the resource managed by the utility data center is received. The categorization of the event is enabled. The automatic generation of a workflow based on the categorization of the event is enabled, and the automatic notification of the utility data center that the change in status has been handled is enabled.

### TECHNICAL FIELD

Embodiments of the present invention relate to managing computing resources. More specifically, embodiments of the present invention relate to communicating resource status changes to a utility data center.

### BACKGROUND ART

Many companies have conventional network operation centers (NOC) for monitoring the status of their computer and software systems. At one period of time a billing application associated with a customers compute resources may need to be executed but at another period of time a payroll application may need to be executed. A conventional utility data center (UDC) can be used for provisioning and re-provisioning resources for various activities monitored by a network operations center. For example, the conventional utility data center can provision resources to the billing application during the period of time that the billing application needs the resources and then re-provision the resources to the payroll application when the payroll application needs the resources.

FIG. 1 depicts a conventional system that includes a conventional network operations center and a conventional utility data center. The utility data center 120 includes event information 124, resource status information 128, a UDC event monitor 122, and a UDC command interface 126. The network operations center 110 includes an operations center (OC) event monitor 112 and a work flow engine 114.

The status associated with a resource managed by a utility data center 120 can change. For example, a resource such as a server may fail. The utility data center 120 updates its status information in the resource status information 128 for the server indicating that the server has failed. The utility data center 120 generates an event indicating that the server has failed. The UDC event monitor 122 communicates that the server has failed to the OC event monitor 112.

An administrator of the network operation center 110 is notified that the server failed. The administrator manually designs a work flow for fixing the failed server. For example, the administrator manually designs a work flow with subtasks indicating the technician is to go to the location of the server and fix it or replace it, then the technician is to manually enter a command indicating that the server has been fixed.

The administrator manually enters the work flow into the work flow engine 114. In performing the subtasks described in the work flow, the technician will manually enter commands that will be received by the UDC command interface 126. For example, after the technician has fixed or replaced the server, the technician will manually enter a command indicating that the server is available to be re-provisioned.

The UDC command interface 126 receives the commands and communicates status information concerning the resource to the UDC 120. The UDC 120 will update the status of the resource in its resource status information 128. For example, when the technician enters the command indicating that the server is available to be re-provisioned, the UDC command interface 126 associated with the UDC 120 receives the command and the UDC 120 will update its resource status information 128 indicating the server is available to be re-provisioned.

The manual process of designing and entering a work flow into the work flow engine 114 is error prone and is costly because of the amount of time it takes.

### DISCLOSURE OF THE INVENTION

Embodiments of the present invention pertain to methods and systems providing a closed loop system for handling a change in status for a resource managed by a utility data center. In one embodiment, an event that describes the change of status for the resource managed by the utility data center is received. The categorization of the event is enabled. The automatic generation of a workflow based on the categorization of the event is enabled, and the automatic notification of the utility data center that the change in status has been handled is enabled.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a conventional system that includes a conventional network operations center and a conventional utility data center (Prior Art).

FIG. 2 is a flow diagram of handling a change in status for a resource managed by a utility data center, according to embodiments of the present invention.

FIG. 3 is a block diagram of a system for handling a change in status for a resource managed by a utility data center, according to embodiments of the present invention.

FIG. 4 depicts flowchart 400 for a method of handling a change in status for a resource managed by a utility data center, according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

A utility data center is used for provisioning and re-provisioning resources needed in a customer's computer facilities. For example, at one period of time a billing application may need to be executed but at another period of time a payroll application may need to be executed. The utility data center can provision resources, such as servers, to the billing application during the period that the billing application needs those resources. When the billing application has finished, the utility data center can re-provision the resources to the payroll application.

The status associated with a resource managed by a utility data center can change. For example, a resource such as a server may fail. The utility data center updates its resource status information for the server indicating that the server has failed. The utility data center generates an event indicating that the server has failed. The utility data center communicates information describing the server and the failure to the network operations center. The network operations center categorizes the event and automatically generates a workflow to solve the problem, according to embodiments of the present invention. The workflow includes descriptions of subtasks that are to be performed to fix the failed server, according to embodiments of the present invention. Once the failed server has been fixed or replaced, the utility data center is automatically notified that the change in status of the server has been handled, according to embodiments of the present invention. For example in this case the utility data center is notified that server has been fixed or replaced. The UDC updates its resource status information indicating the server is available for provisioning.

Although the above example illustrated a failed server as an example of a change of status, there are many other types of changes in the status of resources managed by a utility data center, according to one embodiment. For example, the status of resources change when new software needs to be installed on resources, such as servers. In this case, the status of the servers may be changed from provisioned to de-allocated in order to install the new software on the servers. Therefore, one of the subtasks of the workflow may indicate that the status of the server should be changed from provisioned to de-allocated in order to install the new software on the server. Other subtasks of the workflow may indicate that a technician needs to install the software on the server, the server becomes available for provisioning, for example, by being associated with a “free pool,” and then the server may be provisioned. The utility data center is automatically notified that the change in status of the server has been handled, according to one embodiment. For example in this case, the utility data center may be notified when the server is available for provisioning after the software has been installed, among other things.

### Resources

Resources can be any component that is hardware, software, firmware, or combination thereof that can be used by a data center to provide services rendered by an application, as will become more evident. For example, the resources can be computational servers, firewalls, load balancers, data backup devices, arrays of data storage disks, network appliances, Virtual Local Area Networks (VLANS), and network interface cards (NICs), among other things.

### Farms

A “farm” can be created from one or more resources. For example, resources can be automatically deployed from a pool of resources (e.g., “free pool”) to create a farm. For example, a farm can include various resources, such as a network backbone, firewalls, a cluster of servers and storage devices. The network backbone allows the farm to communicate with the rest of the resources associated with a data center. Applications can be installed and executed on the clusters of servers. Data that the applications create or use can be stored on the storage devices. The firewalls can be used for protecting the applications on the clusters and the data on storage devices.

### A Closed Loop System for Handling a Change in Status for a Resource Managed by a Utility Data Center

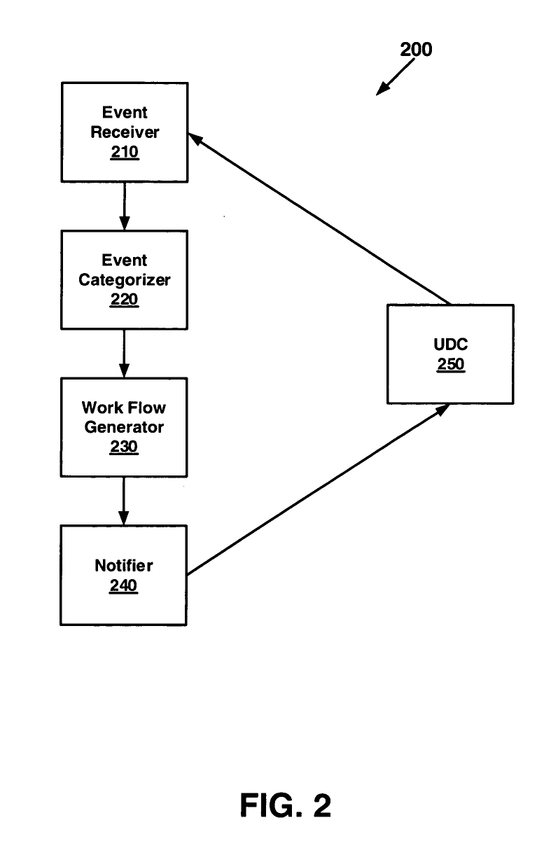

FIG. 2 is a flow diagram of handling a change in status for a resource managed by a utility data center, according to embodiments of the present invention. The blocks that represent features in FIG. 2 can be arranged differently than as illustrated, and can implement additional or fewer features than what are described herein. Further, the features represented by the blocks in FIG. 2 can be combined in various ways. The closed loop system 200 depicted in FIG. 2 can be implemented with software, firmware, hardware or with a combination thereof.

The closed looped system 200 includes an event receiver 210, an event categorizer 220, a workflow generator 230, a notifier 240, and a UDC 250, according to embodiments of the present invention. For example, the event receiver 210 receives an event that describes the change of status for the resource managed by the utility data center 250. The event categorizer 220 enables the categorization of the event. The workflow generator 230 enables the automatic generation of the workflow based on the categorization of the event, and the notifier 240 enables the automatic notification of the utility data center 250 that the change in status has been handled.

Since, according to embodiments of the present invention, the notifier 240 automatically notifies the UDC 250 when the change of a resource's status has been handled, a closed loop communication (e.g., a complete circle of communication) for handling a change in status for a resource managed by the UDC 250 is provided. For example, the process starts and ends with the UDC 250 because the UDC 250 generates the event for the resource that the UDC 250 manages and the UDC 250 is automatically notified when the resource's change in status has been handled.

### A Closed Loop System in the Context of a Utility Data Center and a Network Operations Center

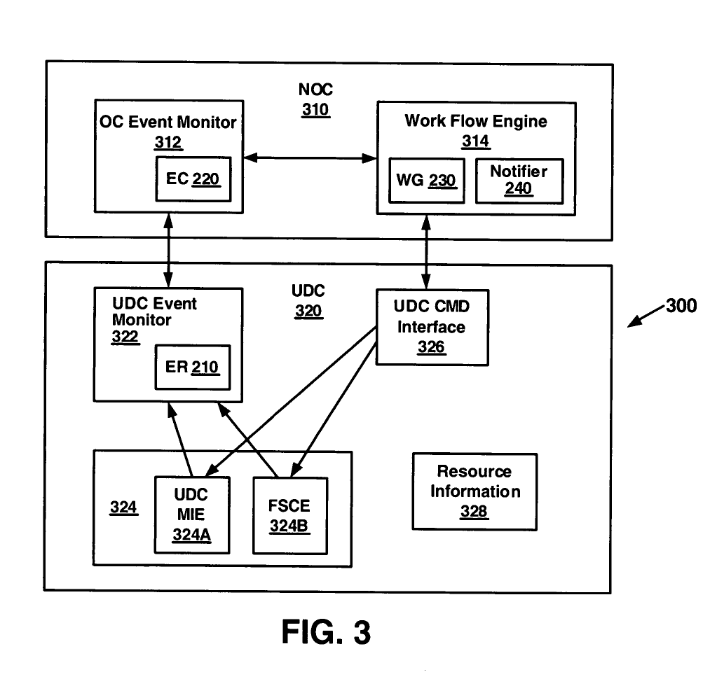

FIG. 3 is a block diagram of a system for handling a change in status for a resource managed by a utility data center, according to embodiments of the present invention. The blocks that represent features in FIG. 3 can be arranged differently than as illustrated, and can implement additional or fewer features than what are described herein. Further, the features represented by the blocks in FIG. 3 can be combined in various ways. The system 300 depicted in FIG. 3 can be implemented with software, firmware, hardware or with a combination thereof.

As depicted in FIG. 3, the system 300 includes a UDC 320 and a NOC 310. The UDC 320 includes a UDC event monitor 322, a UDC command interface 326, event information 324, and resource status information 328. The UDC 320 generates two different types of events, UDC management infrastructure events 324A and farm status change events 324B, as will become more evident. The NOC 310 includes an OC event monitor 312 and a work flow engine 314. Further, the UDC event monitor 322 includes an event receiver 210, the OC event monitor 312 includes an event categorizer 220, and the work flow engine 314 includes a work flow generator 230 and a notifier 240.

For example, when an event is generated, for example due to a change in status for a resource, the event receiver 210 receives information describing the change in status. Since the UDC 320 manages the resource, the UDC 320 has a lot of information pertaining to the resource and can provide this information to the event receiver 210. The event receiver 210, according to one embodiment, formats the information using a standardized format, such as Extensible Markup Language (XML). The UDC event monitor 322 uses the standardized format to communicate the information describing the event to the OC event monitor 312. The event categorizer 220 associated with the OC event monitor 312 uses the information to categorize the event, as will become more evident. The information describing the event and the categorization of the event are communicated to the work flow engine 314. The work flow generator 230 associated with the work flow engine 314 uses the information describing the event and the categorization of the event to automatically generate a work flow. A technician can validate the work flow. The subtasks described by the work flow can be performed in order to handle the change of status of the resource. For example, if the resource has failed, the resource can be fixed or replaced.

The UDC 320 is automatically notified that the change of status for the resource has been handled, according to one embodiment. For example, the notifier 240 associated with the work flow engine 314 automatically issues commands that the UDC command interface 326 receives. Continuing the example, the notifier 240 can automatically issue a command indicating that the failed resource has been fixed or replaced thus enabling the UDC 320 to update the status of the resource associated with the resource status information 328 indicating that the resource functional again.

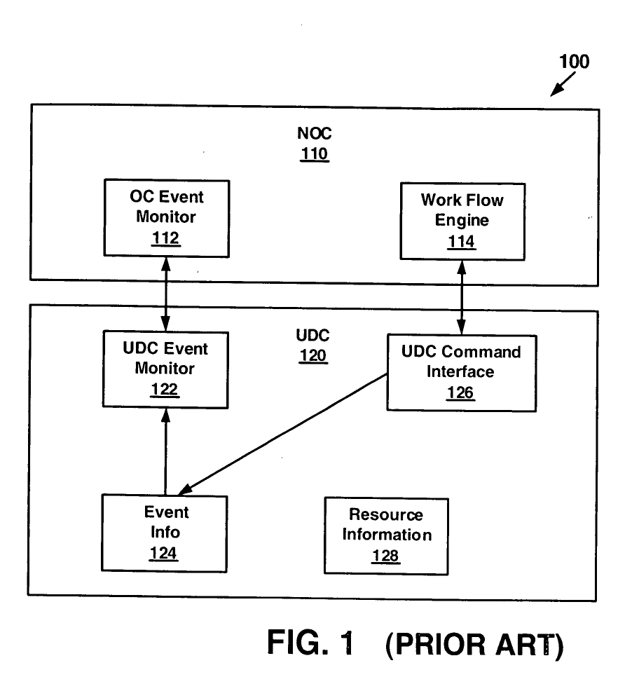

With conventional UDCs 120 the OC event monitor 112 receives information indicating that a resource is up or down, and may or may not receive additional information about the event. In contrast, according to embodiments of the present invention, the OC event monitor 312 receives enough information to enable the event categorizer 220 to categorize the event. As already stated, with conventional network operation centers, a work flow was manually designed and entered into the work flow engine 114. In contrast, according to embodiments of the present invention, the work flow generator 230 associated with the work flow engine 314 automatically generates work flows based, at least in part, on the categorization of the event. Further, as already stated, in a conventional system 100 (FIG. 1), commands indicating that the change of status of a resource had been handled were manually entered into a UDC command interface 126. In contrast, according to embodiments of the present invention, the notifier 240 automatically notifies the UDC 320 when the change of a resource's status has been handled, thus, providing a closed loop communication (e.g., a complete circle of communication) for handling a change in status for a resource managed by the UDC 320.

As a result, problems associated with a UDC 320 can be automatically responded to and rectified. Further, most problems can be handled by the work flow engine 314 without human intervention. If human intervention is required, the work flow engine 314 will identify and manage the subtasks that should be performed, according to embodiments of the present invention. Thus, the costs of operating a utility data center 320 will be reduced and the manual configuration of a work flow engine 314 is significantly reduced if not eliminated, according to embodiments of the present invention.

### Error Messages

Several error messages are typically generated due to one change in status of a resource managed by a utility data center 320. For example, a resource, such as a storage device, may fail. An error message is generated indicating that the storage device failed. Other error messages are also generated indicating that various applications cannot access information on the storage device that failed or that applications are not responding or have degraded performance.

According to embodiments of the present invention, the error messages are analyzed and filtered to determine the core problem, as will become more evident. According to one embodiment, the importance of applications can be prioritized and error messages that impact applications with high priorities may be given higher priority. For example, a payroll application may be given a higher priority than a test application. Therefore, error messages that impact the payroll application may be given higher priority that error messages that impact the test application.

### Events

As already stated, utility data centers 320 generate events as a result of the status of a resource changing. Events can require actions in order to be handled (referred to herein as “actionable events”) or may not require action in order to be handled (referred to herein as “non-actionable events”). An example of an actionable event is a server failing that requires a technician to fix or replace the server. An example of a non-actionable event is an event that only provides information and therefore does not require any action in order to be handled. For actionable events, the work flow engine 314 needs enough information concerning the event in order to generate a work flow that will handle the change of status, according to one embodiment.

Events can be due to a problem or due to some normal operation. An example of a problem is a server failing. Examples of a normal operation would be allocating, provisioning, and de-allocating servers for example in order to automatically provide resources during a period of time such as Christmas when an application would need more resources in order to handle the increased demand.

Events can be generated due to a change in the UDC infrastructure or due to a farm state change. A UDC management infrastructure event 324A results from any change in the UDC infrastructure. The UDC infrastructure is any component needed to make the UDC operate. The UDC infrastructure does not include “farms” which are created and managed by the UDC.

A farm state change event 324B results from any action that effects the state of a farm or of any of the components in the farm. Examples of farm state change events 324B include a farm device fails, a farm is placed on standby, or a device is de-activated.

According to one embodiment, a standardized format is used for formatting an event. According to one embodiment, the standardized format that is used for formatting events is XML. By using XML different OC event monitors 312 associated with different network operations centers can communicate with each other. By using XML various parts of the system can be implemented using competitor products. For example, the UDC event monitor 322 and the UDC command interface 326 may be implemented using HP's Open View™, while the OC event monitor 312 and work flow engine 314 may be implemented using IBM's Tivoli™, or vice versa.

According to one embodiment, events are categorized. The events can be categorized based on generic types of problems. For example, events that pertain to certain types of database errors can be placed in particular categories and events that pertain to server errors may be placed in other categories. The categories can be as fine grained as desired. For example, there may be a category to handle database table spaces being full and another category for corrupted data in a database. As will become more evident, templates can be used for categorizing events.

A system 300 can be configured to handle events automatically or to require authorization for events. For example, a system can be configured to require that an operator or technician review a work flow and approve it before the work flow is used to handle the change in status of a resource or the system can be configured to automatically handle the change in status without review and approval. More specifically, in the later case, if a resource fails, instead of having a technician replace or fix the resource, the UDC 320 can automatically de-allocate the resource and allocate another resource to replace the defective resource.

### UDC Event Monitor

The UDC event monitor 322 detects events in the UDC 320 and forwards information about selected events to the OC event monitor 312. According to one embodiment, the event receiver 210 associated with the UDC event monitor 322 receives the event. In another embodiment, the event receiver 210 uses XML to format the event, as already described herein.

As already stated, in a conventional system 100 (FIG. 1), events indicated if a resource is up or down and may or may not provide additional information. According to embodiments of the present invention, enough information about an event is communicated to the OC event monitor 312 so that the OC event monitor 312 can categorize the event. UDC 320 manages all of the resources that it provisions. So the UDC 320 has lots of information about the resource. Therefore, the event receiver 210 associated with the UDC 320 can provide enough information to the event categorizer 220 associated with the OC event monitor 312 so that the event categorizer 220 can categorize the event and in turn enough information is provided to the work flow engine 314 so that the work flow generator 230 can generate a work flow for solving the change in resource status that resulted in the event. Examples of information include resource status (such as failed, operational, provisioned, de-allocated), the reason for the resource's status (such as why the resource failed), where the resource is located, and so on.

According to embodiments of the present invention, which UDC event monitor 322s, OC event monitors 312 and work flow engine 314s communicate with each other is configurable. Further, the UDC event monitor 322 can be configured to communicate with more than one OC event monitor 312.

According to one embodiment, the UDC event monitor 322 may be implemented by a product like HP Openview Operators™, IBM Tivoli™, or BMC Patrol™. The UDC event monitor 322 and the OC event monitor 312 can use standardized interfaces to communicate, according to one embodiment. The UDC event monitor 322 and the OC event monitor 312 could use a web server publish and subscribe to communicate.

### OC Event Monitor

As already stated, the UDC event monitor 322, according to embodiments of the present invention, forwards information about selected events to the OC event monitor 312 associated with a network operations center. The event categorizer 220 associated with the OC event monitor 312 receives the event information, for example in an XML format. The OC event monitor 312 creates a template for the event and the event categorizer 220 associated with the OC event monitor 312 uses the template to categorize the event, according to embodiments.

Templates can be used for categorizing database errors, server errors, and so on. Templates can be as fine grained as desired, according to another embodiment. For example, templates can be for categorizing that a databases table space is full or that the data in a database has been corrupted. New types of templates can be created for categorizing new or additional types of events, according to yet another embodiment.

According to one embodiment, the OC event monitor 312 sends acknowledgements to the UDC event monitor 322 for events that have been “acknowledged” either through the work flow engine 314 or by a local operator using the OC event monitor 312.

The OC event monitor 312 can be implemented using HP Openview Operations™, according to one embodiment. Further the OC event monitor 312 can communicate with several UDCs 320, according to another embodiment. According to another embodiment, the functionality of the OC event monitor 312 is put into the UDC event monitor 322.

### Filters

As already stated, several error messages are typically generated due to one change in status of a resource managed by a utility data center. Filters are used for determining the original resource status change that caused the error messages, according to embodiments of the present invention. For example, if a storage device failed which resulted in error messages not only for the failed storage device, but also indicating that applications are not responding and so on. Filters can be used for identifying the core error message that indicates that all of the other error messages result from the storage device failure. If the filters cannot determine the core error message, the filters can be used to filter down to a few of the most likely error messages that pertain to the original resource status change that caused the error messages.

Filters can be associated with the UDC event monitor 322 or the OC event monitor 312 or both, according to embodiments of the present invention. Filter associated with the UDC event monitor 322 could allow, for example, many error messages to be communicated to the OC event monitor 312 or could be restrictive in allowing few error messages to be communicated to the OC event monitor 312. If the former, then a filter associated with the OC event monitor 312 may perform more filtering of error messages.

According to one embodiment, the OC event monitor 312 uses filters that specify which events need to be processed by a work flow engine 314. The events selected using the filters are communicated to the work flow engine 314 and acknowledged when notified by the work flow engine 314 that the work flow resulting from this event has been completed, for example.

### Workflow Engine

According to embodiments of the present invention, the work flow engine 314 receives actionable events, or information describing the actionable events. For example, an actionable event may be generated when a device fails. In this case, an operator may be required to approve whether a new device should be allocated. The operator may also need to take corrective action to replace or fix, among other things, the failed device.

The work flow generator 230 associated with the work flow engine 314 automatically generates a work flow for handling the change in status of a resource, according to one embodiment. For example, the resource may be a power supply and the change in status may be that the power supply has failed. An example of handling the change in status of the resource may be fixing or replacing the power supply. In this case, the work flow generator 230 can generate a work flow with subtasks indicating the technician is to go to the location of the power supply at rack 59 slot 3, the technician is to fix or replace the power supply, and then the notifier 240 is to automatically issue a command indicating that the power supply has been fixed.

According to embodiments of the present invention, the work flow generator 230 uses algorithms for generating the work flow. For example, the algorithms may indicate that a farm is to be automatically re-provisioned (also commonly known as “flexing”). In another example, the algorithms may indicate that an entire environment is to be rebuilt. In this case, the work flow would include many subtasks to instruct operators to replace all of the resources associated with the environment, to configure all of the resources associated with the environment, to update appropriate resource status information 328 for all of the resources, and so on.

The algorithms use generalized rules for generating work flows, according to embodiments of the present invention. For example, many types of resource status changes can be handled using subtasks that can be determined ahead of time and the work flow generator 230 can be implemented in a way to take advantage of this. More specifically, in the case of a server failure, it can be determined that a generalized rule for handling server failures would be to first go to the location of the server, replace or fix the server, and then have the notifier 240 automatically issue a command indicating that the server is available for provisioning. According to one embodiment, the subtasks are implemented to interface with the UDC 320.

Standard open view communications are used between the OC event monitor 312 and the work flow engine 314, according to one embodiment. Any standardized interface or protocol can be used for communicating between the OC event monitor 312 and the work flow engine 314, according to one embodiment. The work flow engine 314 is implemented with OV service desk™, according to one embodiment.

### The Notifier and the UDC Command Interface

UDC 320 has resource status information 328, as already stated according to one embodiment. When a device “A” has failed the UDC 320 indicates in the resource status information 328 for device “A” that device “A” has “failed.” UDC 320 needs to be notified when device “A” has been fixed or replaced so that the UDC 320 can update its resource status information 328.

In conventional system 100, the commands for communicating with the UDC 320 were entered manually by a data center operator. UDC command interface 326 can receive commands, such as commands for provisioning a server, shutting down a server, or starting a server. In contrast according to embodiments of the present invention, the notifier 240 associated with the work flow engine 314 can determine based on the automatically generated work flow, for example among other things, which commands need to be issued in order to notify the UDC 320 that a change in status has been handled. The UDC command interface 326 receives the commands that the notifier 240 automatically issues, thus, the UDC 320 is notified that the change in status of a resource has been handled.

### Operational Example

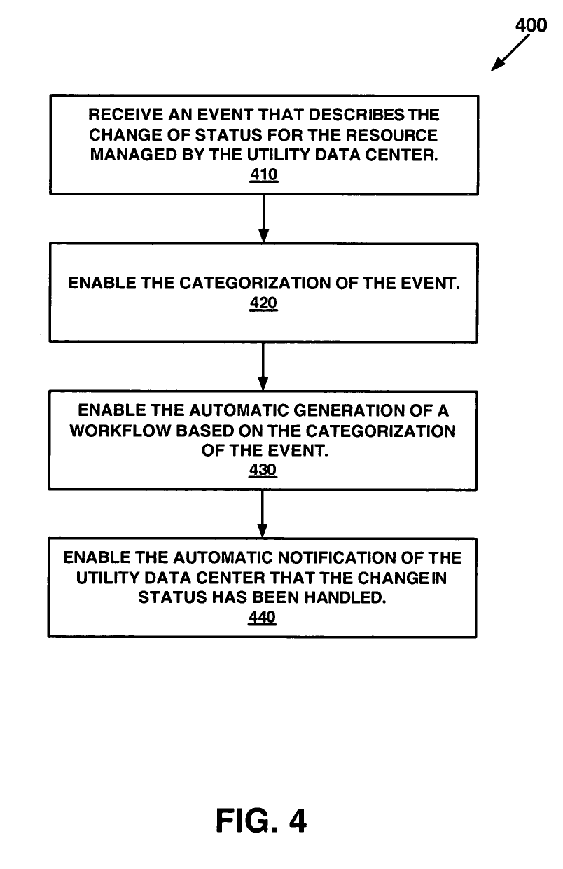

FIG. 4 depicts flowchart 400 for a method of handling a change in status for a resource managed by a utility data center, according to embodiments of the present invention. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in flowchart 400 may be performed. All of, or a portion of, the embodiments described by flowchart 400 can be implemented using computer-readable and computer-executable instructions which reside, for example, in computer-usable media of a computer system or like device.

For the purposes of illustration, the discussion of flowchart 300 shall refer to the structures depicted in FIG. 3. Further, for the purposes of illustrating the following operational example, it shall be assumed that a power supply located at rack 59 slot 4 has failed. It shall also be assumed that the power supply is for a server provisioned on a farm that a high priority billing application is executing on. As a result of the power supply failing, an event associated with the farm state change events 324B is generated. Further numerous error messages are generated. For example, an error message indicating the power supply has failed is generated. Further error messages indicating the server is not functioning are generated and error messages indicating that the billing application is not responding are also generated. The UDC 320 updates its resource status information 328 to indicate that the power supply has failed.

In step 410, an event that describes the change of status for the resource managed by the utility data center is received, according to one embodiment. For example, the power supply is managed by the UDC 320. The UDC 320 has lots of information about the power supply stored in the resource status information 328. The event receiver 210 associated with the UDC event monitor 322 receives the event that describes that the power supply has failed. The event includes the information about the power supply from the resource status information 328. For example, the event can include the location of the power supply, the status of the power supply, the type of power supply, and so on.

The UDC event monitor 322 receives the various error messages that result from the failed power supply. The UDC event monitor 322 filters the error messages, according to embodiments described herein, in attempting to determine the core problem (e.g., that the power supply failed and this has resulted in the proliferation of error messages).

The event receiver 210 formats the event into a standardized format, such as XML, according to one embodiment. The UDC event monitor 322 communicates the event in the standardized format to event categorizer 220 associated with the OC event monitor 312 that resides in the NOC 310.

In step 420, the categorization of the event is enabled, according to another embodiment. For example, the event categorizer 220 receives the event in the standardized format and uses the information associated with the event to categorize the event. Many templates may be associated with the OC event monitor 312 that can be used for the purposes of categorizing the event. For example, a template for power supplies may be used to categorize the event that was generated as a result of the power supply failing.

More filtering of error messages may also be performed by the OC event monitor 312, according to embodiments described herein. For example, filtering of error messages can be performed by either the UDC event monitor 322 or the OC event monitor 312 or by both of them (312, 322). The OC event monitor 312 communicates the event and the categorization of the event, among other things, to the work flow engine 314.

In step 430, the automatic generation of a workflow based on the categorization of the event is enabled, according to yet another embodiment. For example, the work flow generator 230 associated with the work flow engine 314 can use the categorization of the event to automatically generate a work flow. For example, there may be a generalized rule for generating work flows that pertain to failed power supplies. The generalized rule may specify that a technician is to go to the location of the power supply, which in this operational example is at rack 59 slot 4, and replace the power supply. Further, the generalized rule may specify that once the power supply has been replaced, the notifier 240 associated with the work flow engine 314 should automatically notify the UDC command interface 326 associated with the UDC 320, that the power supply is operational again.

The work flow generator 230 uses the generalized rule for failed power supplies to generate a work flow. A technician reviews the work flow and follows the subtasks that pertain to the technician. In this case, the subtasks that pertain to the technician are to go to rack 59 slot 4 and replace the power supply.

In step 440, the automatic notification of the utility data center that the change in status has been handled is enabled, according to still another embodiment. For example, once the power supply has been replaced, the notifier 240 associated with the work flow engine 314 automatically notifies the UDC command interface 326 associated with the UDC 320, that the power supply is operational again. In response to receiving the command, the UDC 320 updates the resource status information 328 to indicate that the power supply is operational again, thus, a closed loop for handling a change in status for a resource (e.g., which in this operational example is a failed power supply) managed by the UDC 320 is provided.

What is claimed is:

1. A method of handling a change in status for a resource managed by a utility data center, the method comprising:
receiving an event that describes the change of status for the resource managed by the utility data center;
enabling the categorization of the event;
enabling the automatic generation of a workflow based on the categorization of the event; and
enabling the automatic notification of the utility data center that the change in status has been handled.

2. The method as recited in claim 1, wherein:
the method further comprises formatting the event in a standardized format; and
the enabling of the categorization of the event further comprises using the event in the standardized format to categorize the event.

3. The method as recited in claim 2, wherein the formatting the event in a standardized format further comprises formatting the event in extensible markup language (XML).

4. The method as recited in claim 1, wherein the method further comprises:
using templates to categorize the event.

5. The method as recited in claim 1, wherein the enabling the automatic generation of the workflow further comprises:
using algorithms with generalized rules for handling events to generate the work flow.

6. The method as recited in claim 1, wherein the method further comprises:
receiving numerous error messages that were generated as a result of the change in status of the resource; and
filtering the error messages in order to identify a core error message that pertains to the change in status of the resource.

7. The method as recited in claim 1, wherein the enabling the automatic notification of the utility data center further comprises:
notifying the utility data center that the change in status has been handled; and
updating the resource status information associated with the utility data center to indicate that the change in status has been handled.

8. A system for handling a change in status for a resource managed by a utility data center, the method comprising:
an event receiver for receiving an event that describes the change of status for the resource managed by the utility data center;
an event categorizer for enabling the categorization of the event;
a workflow generator for enabling the automatic generation of a workflow based on the categorization of the event; and
a notifier for enabling the automatic notification of the utility data center that the change in status has been handled.

9. The system of claim 8, wherein:
the event receiver formats the event in a standardized format;
the event categorizer receives the event in the standardized format; and
the event categorizer uses the event in the standardized format to categorize the event.

10. The system of claim 9, wherein the standardized format is extensible markup language (XML).

11. The system of claim 8, wherein the event categorizer uses templates to categorize the event.

12. The system of claim 8, wherein the work flow generator uses algorithms with generalized rules for handling events to generate the work flow.

13. The system of claim 8, wherein a component selected from a group consisting of the event receiver and the event categorizer:
receives numerous error messages that were generated as a result of the change in status of the resource; and
filters the error messages in order to identify a core error message that pertains to the change in status of the resource.

14. The system of claim 8, wherein:
the notifier notifies the utility data center that the change in status has been handled; and
the utility data center updates the resource status information associated with the utility data center to indicate that the change in status has been handled.

15. A computer-usable medium having computer-readable program code embodied therein for causing a computer system to perform a method of handling a change in status for a resource managed by a utility data center, the method comprising:
receiving an event that describes the change of status for the resource managed by the utility data center;
enabling the categorization of the event;
enabling the automatic generation of a workflow based on the categorization of the event; and
enabling the automatic notification of the utility data center that the change in status has been handled.

16. The computer-usable medium of claim 15, wherein the computer-readable program code embodied therein causes a computer system to perform the method, and wherein:
the method further comprises formatting the event in a standardized format; and
the enabling of the categorization of the event further comprises using the event in the standardized format to categorize the event.

17. The computer-usable medium of claim 16, wherein the computer-readable program code embodied therein causes a computer system to perform the method, and wherein:
the formatting the event in a standardized format further comprises formatting the event in extensible markup language (XML).

18. The computer-usable medium of claim 15, wherein the computer-readable program code embodied therein causes a computer system to perform the method, and wherein the method further comprises:
using templates to categorize the event.

19. The computer-usable medium of claim 15, wherein the enabling the automatic generation of the workflow further comprises:
using algorithms with generalized rules for handling events to generate the work flow.

20. The computer-usable medium of claim 15, wherein the computer-readable program code embodied therein causes a computer system to perform the method, and wherein the method further comprises:
receiving numerous error messages that were generated as a result of the change in status of the resource; and
filtering the error messages in order to identify a core error message that pertains to the change in status of the resource.

21. The computer-usable medium of claim 15, wherein the computer-readable program code embodied therein causes a computer system to perform the method, and wherein the enabling the automatic notification of the utility data center further comprises:
notifying the utility data center that the change in status has been handled; and
updating the resource status information associated with the utility data center to indicate that the change in status has been handled.
